(19) United States
(12) Patent Application Publication
(10) Pub. No.: US 2020/0350717 A1
(43) Pub. Date: Nov. 5, 2020

(54) CARD EDGE CONNECTOR WITH IMPROVED CONTACTS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: YUAN-YUAN DONG, Kunshan (CN); XIAO-HU YIN, Huaian (CN); GUO-XIANG NIU, Huaian (CN); WEN-JUN TANG, Kunshan (CN); XUN WU, Kunshan (CN)

(21) Appl. No.: 16/864,147

(22) Filed: Apr. 30, 2020

(30) Foreign Application Priority Data
May 3, 2019 (CN) 201910366296.1
May 3, 2019 (CN) 201920624084.4
May 22, 2019 (CN) 201910426725.X

(51) Int. Cl. H01R 12/72; H01R 13/646; H01R 13/11

(52) U.S. Cl. CPC H01R 12/721; H01R 12/737; H01R 13/11; H01R 13/646

(57) ABSTRACT

A card edge connector includes a longitudinal insulating housing including two long walls and a bottom wall connecting with the long wall and defining a card slot in a longitudinal direction among the long walls and the bottom wall, two rows of contact arranged in the long walls respectively. Each contact includes a retaining portion, a spring portion extending from the retaining portion and leg portion extending from the retaining portion and out of the insulating housing. The spring portions define contacting portions projecting into the card slot. Each contact is formed by directly punching out from a metal plate, the retaining portions define an outer edge and inner edge interfered with the insulating housing and two opposite plane faces connecting with the outer and inner edge and disposed perpendicular to the longitudinal direction.

### FIELD OF THE DISCLOSURE

The invention is related to a card edge connector, and particularly to a card edge connector with improved contacts.

### DESCRIPTION OF RELATED ARTS

Currently, a card edge connector is used to connect a card module card to a printed circuit board. US20190190212A1 discloses a card edge connector, which includes an elongate insulating housing, contacts retained in the housing and a ground member. The ground member is assembled in the bottom of the housing and includes a plurality of spring fingers elastically pressing against corresponding ground contacts of the contacts. The insertion of the ground member will make a task of crack of the housing.

Therefore, it is desired to provide a new card edge connector.

### SUMMARY OF THE DISCLOSURE

To achieve the above desire, a card edge connector comprises a longitudinal insulating housing comprising two long walls and a bottom wall connecting with the long wall and defining a card slot in a longitudinal direction among the long walls and the bottom wall, two rows of contact arranged in the long walls respectively, each contact includes a retaining portion, a spring portion extending from the retaining portion and leg portion extending from the retaining portion and out of the insulating housing. The spring portions define contacting portions projecting into the card slot. Each contact is formed by directly punching out from a metal plate, the retaining portions define an outer edge and inner edge interfered with the insulating housing and two opposite plane faces connecting with the outer and inner edge and disposed perpendicular to the longitudinal direction.

### BRIEF DESCRIPTION OF THE DRAWINGS

FIG. 1 is a top perspective view of a card edge connector according to a first embodiment of the present invention;

FIG. 2 is a bottom perspective view of FIG. 1;

FIG. 3 is a top perspective view of the card edge connector, wherein parts of the connector are cut away;

FIG. 4 is an exploded perspective view of the card edge connector of FIG. 1 and a circled partially enlarged portion;

FIG. 5 is a perspective view of a par of the contacts and the ground member;

FIG. 6 is a perspective view of two pairs of the contacts;

FIG. 7 is a cross-sectional view of the card edge connector according taken along line 7-7 in FIG. 1;

FIG. 8 is a top perspective view of a card edge connector according to a second embodiment of the present invention;

FIG. 9 is a bottom perspective view of the card edge connector of FIG. 8 and a circled partially enlarged portion;

FIG. 10 is a top perspective view of the card edge connector of FIG. 8, wherein parts of the connector are cut away;

FIG. 11 is an exploded perspective view of the card edge connector of FIG. 8;

FIG. 12 is a perspective view of parts of the contacts and the ground member;

FIG. 13 is a perspective view of two pairs of the contacts;

FIG. 14 is a cross-sectional view of the card edge connector taken along line 14-14 in FIG. 8;

FIG. 15 is a top exploded perspective view of a card edge connector according to a third embodiment of the present invention;

FIG. 16 is a bottom exploded perspective view of the card edge connector of FIG. 15;

FIG. 17 is a top perspective view of the card edge connector of the third embodiment, wherein parts of the connector are cut away; and

FIG. 18 is a cross sectional view of the card edge connector of the third embodiment.

### DETAILED DESCRIPTION OF THE PREFERRED EMBODIMENT

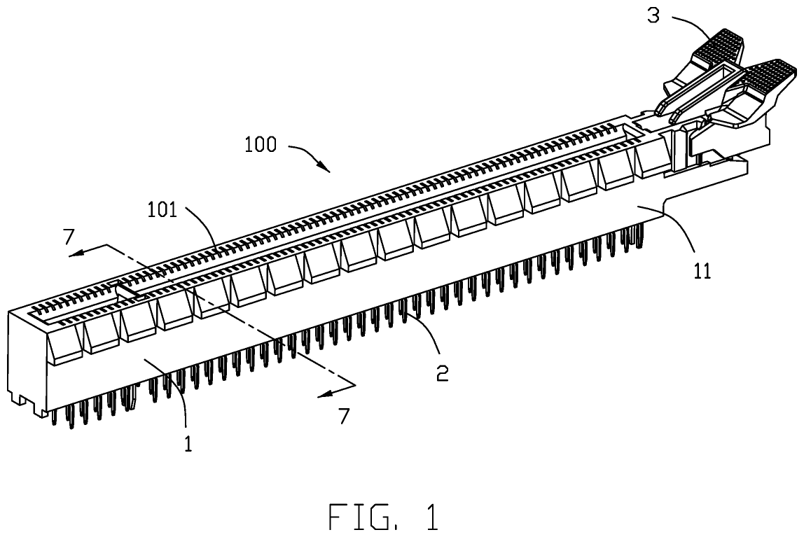

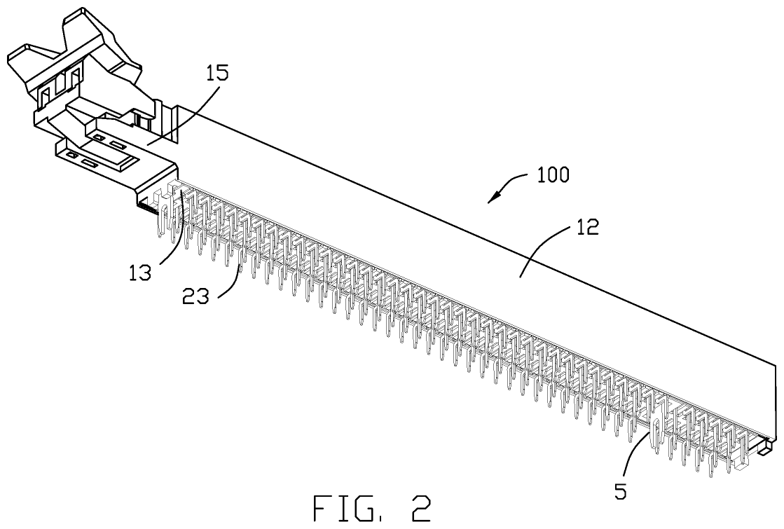

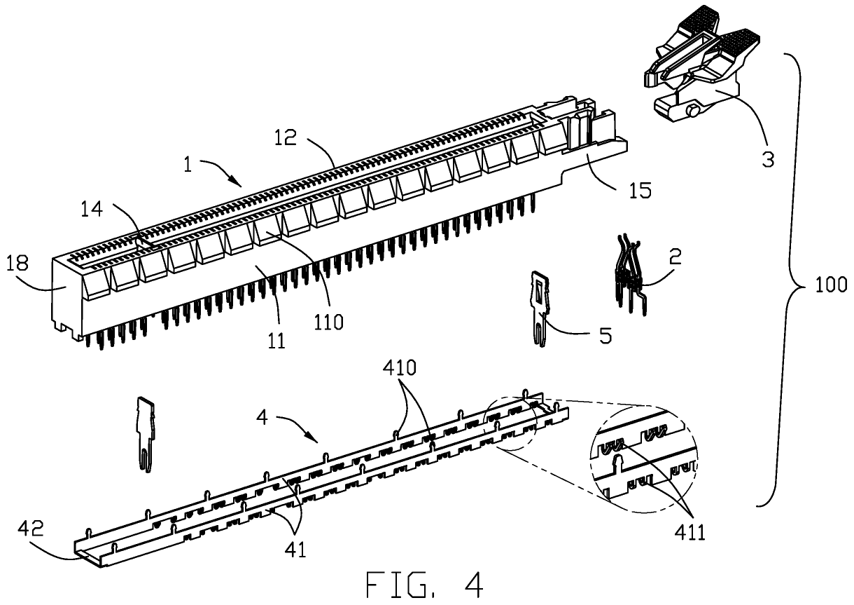

Referring to FIGS. 1-7 illustrating a first embodiment of this invention, this embodiment of this invention is a card edge connector 100, which includes an elongate insulative housing 1, a plurality of contacts 2, a locker 3, a grounding member 4 and a pair of board locks 5.

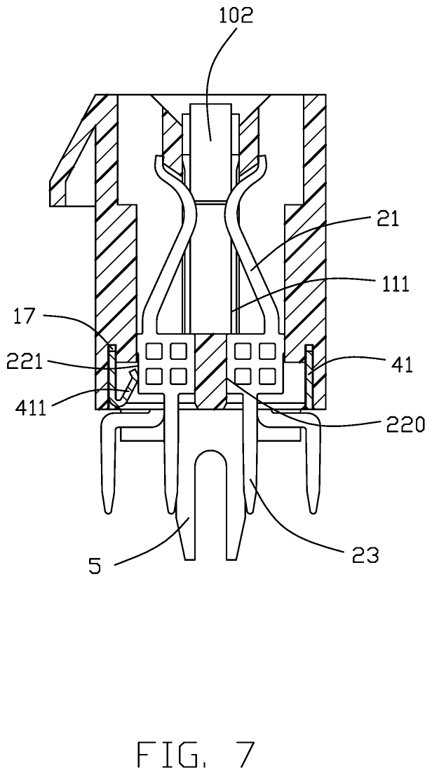

Referring to FIGS. 1-4, the longitudinal insulating housing 1 defines a top mating face 101 and includes two opposite long walls 11, 12 or sidewalls defining a car slot 102 between the two long walls 11, 12, and a bottom wall 13 connecting with the long walls in a transverse direction perpendicular to the long walls, and two opposite short walls 18 or end walls, each connecting with longitudinal ends of the long walls. The long walls 11, 12 is longer than the short walls 18 The board locks 5 are retained in the bottom of the short walls 18, respectively. One long wall 11 defines a row of projectors 110 near to the mating face 101, in the transverse direction, which are separated from each other in the longitudinal direction. The other long wall 12 has a plane face. A mounting portion 15 integrally extends outward in the longitudinal direction and offer to contain the locker 3. A key 14 is in the card slot 102 and integrally connecting with the opposite long walls 11, 12. Each long wall defines a row of contact grooves 16 to receive the contacts 2 one by one and a receiving slot 17 running through the bottom face to receive the grounding member 4 as best shown in FIG. 7.

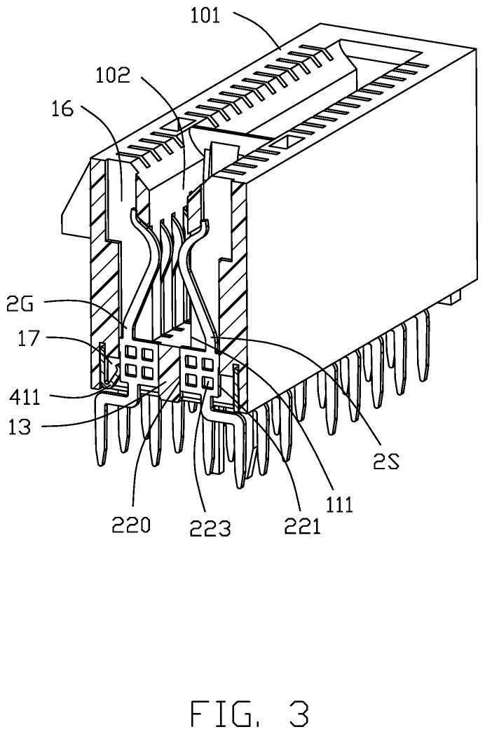

Referring to FIGS. 3-7, the contacts 2 are categorized into two rows in the long walls. Each contact includes a retaining portion 22, a spring portion 21 extending from the retaining portion and a leg portion 23 extending from the retaining portion and out of the insulating housing 1. The spring portion 21 defines a contacting portion 210 arched into the card slot 102 to be contacted with a card inserted in the card slot 102. The contacts 2 are blanking contacts, that is, each contact 2 is punched out a blank from a metal plate, contacting points are provided on a cutting surface of the blank. The retaining portion 22 defines an outer edge 221 and an inner edge 220 nearer to the card slot 102 than the outer edge 221 in the transverse direction, and two opposite plane surfaces 222 connecting with the outer and inner edges, and an upper and a lower edge (not label). It's clearly shown that the plane surfaces 222 are larger than each of the edges of the retaining portions 22. The plane surfaces 224 are disposed perpendicular to the longitudinal direction. The outer edges 221 with bars 225 are interfered with the long walls and the inner edges 220 project inward and are interfered with the inside face of the contact grooves 16. It is clearly shown the interfered area of each contact with the insulating housing 1 is increased. The inner edges 220 are located beyond the inner surfaces 111 of the long wall viewed from a top side.

Referring to FIG. 3-7, the retaining portion 22 defines at least two through holes 223 running through opposite plane surfaces 222 in the longitudinal direction, thereby bringing a little of elasticity of the retaining portion 22. In preferred embodiment, the retaining portion 22 defines two rows of through holes 223. In alternative embodiment, the retaining portion has two through holes arranged in the transverse direction or in the upright direction,

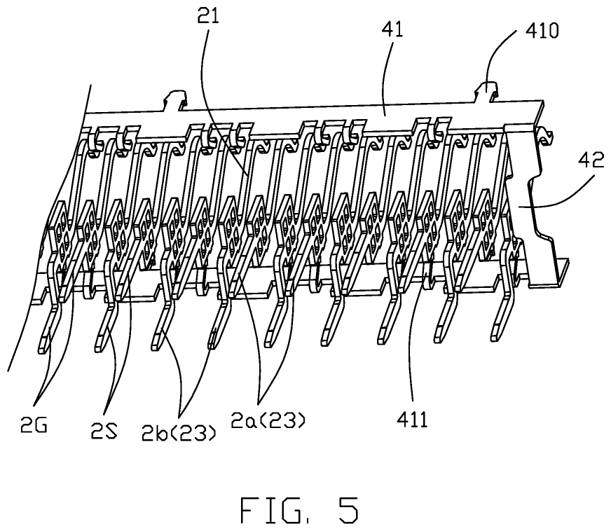

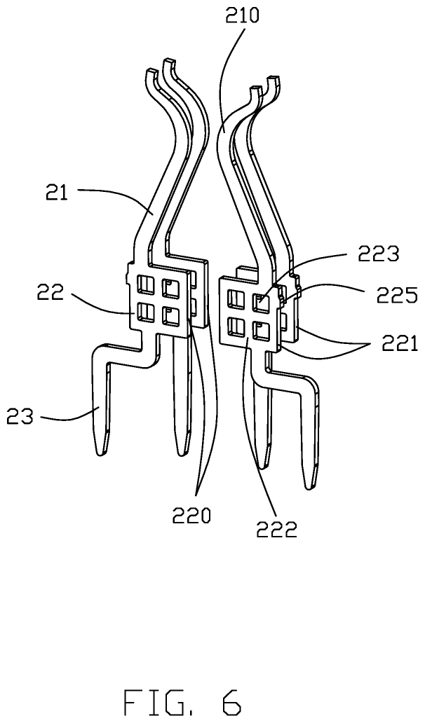

Referring to FIG. 5-6, each row of the contacts 2 includes first contacts 2a and second contacts 2b alternative one by one. The leg portions 23 of the first contacts 2a extend downwards straight from a middle point of the bottom edge thereof while leg portion 23 of the second contacts 2b extend downward and shift outwards, therefore, the leg portions of the second contacts 2b are located at outside of the leg portions of the first contacts 2a. The spring portions 21 of the first and second contacts extending from an outer point of the upper edges of the retaining portions 22. As best shown in FIG. 5, the leg portions of the contacts in each long wall are arranged in two rows, the leg portions of the first contacts are located in the inside of the leg portions of the second contacts., while the spring portions 21 and the retaining portions 22 are still in one row. Therefore, the distance between adjacent leg portions 23 increases, making convent of holes defined on printed circuit board where the connector is seated.

Each row of contacts includes a plurality of signal contacts 2S and a plurality of ground contacts 2G. The grounding member 41 retained in the long wall defines contact sections in the form of spring fingers 411 corresponding to the ground contacts 2G. The spring fingers 411 elastically press against the ground contacts 2G, thereby establishing a grounding path of the grounding member 4 and the ground contacts 2G so as to improve high frequency performance. In preferred embodiment, the grounding member includes two long plate 41 and two short plate 42 connecting two ends of the long walls. The ground member 4 is mounted from the bottom face of the insulating housing and the long plates 41 are received in the receiving slot 17 vertically or parallel to the long walls. The spring fingers 411 extend downward from the bottom edges of the long plate 41 and then slant upwards toward the retaining portion 22. The spring fingers 411 elastically press against the outer edge 211 of the retaining portions. The long plate 41 are distant from and disconnect with the retaining portions 22 of the signal contacts 2S. A plurality of retaining rib 410 extend upwards from an upper edge of the long plate 41 and retain in the long wall.

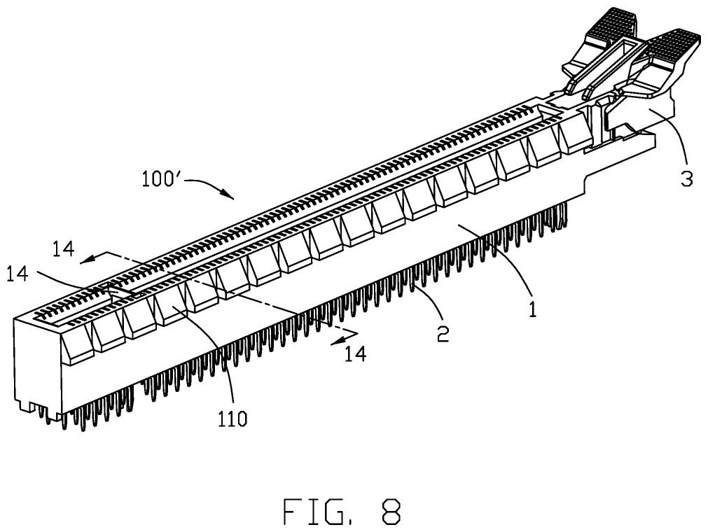

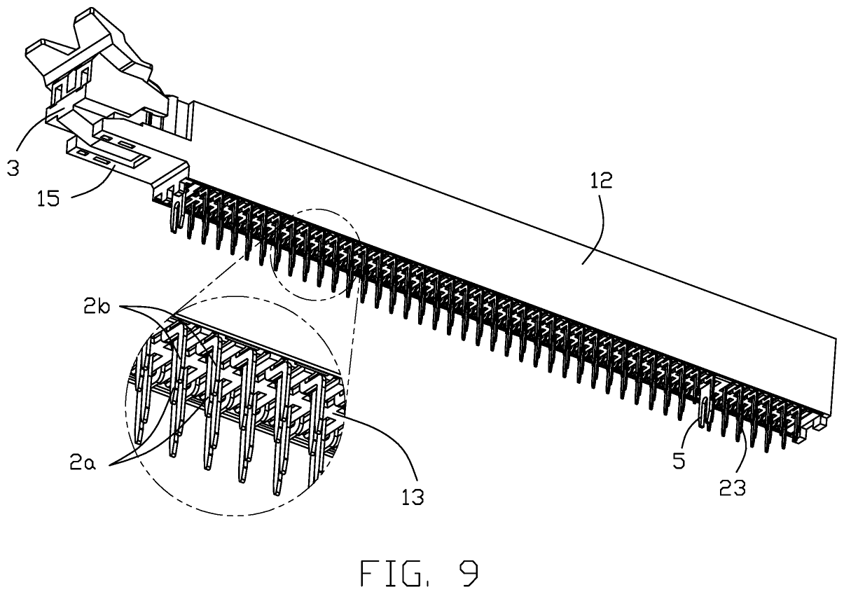

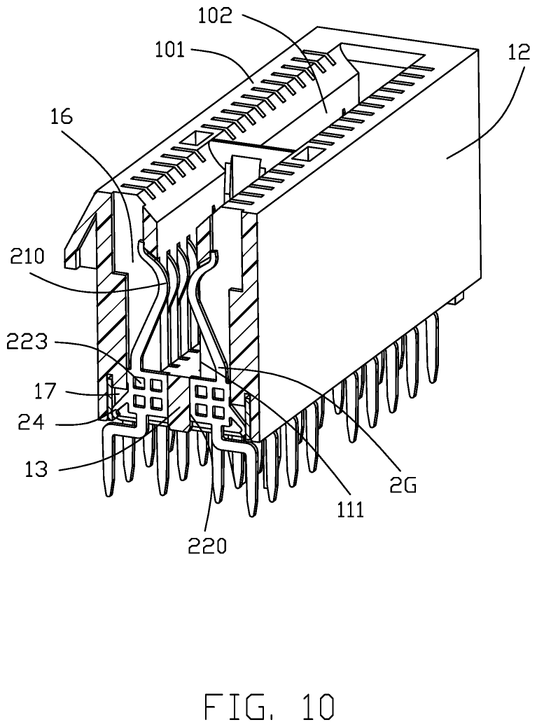

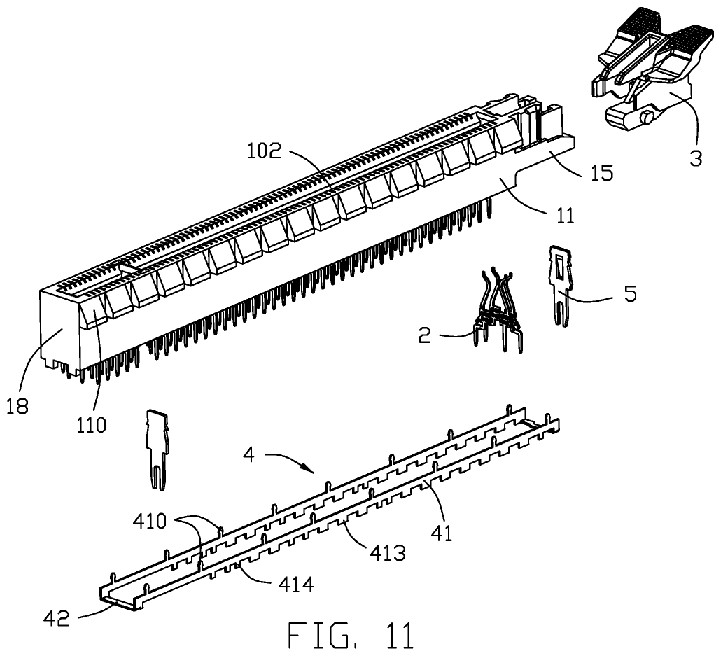

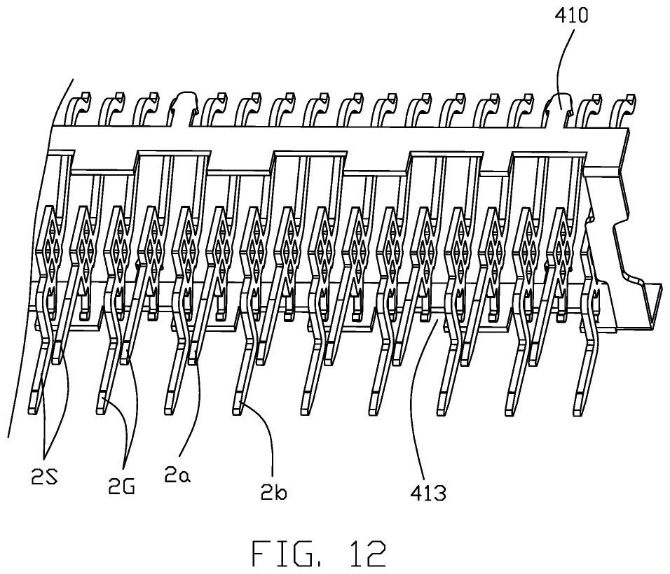

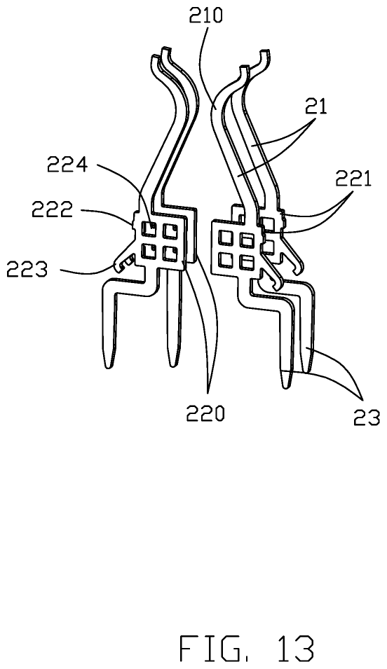

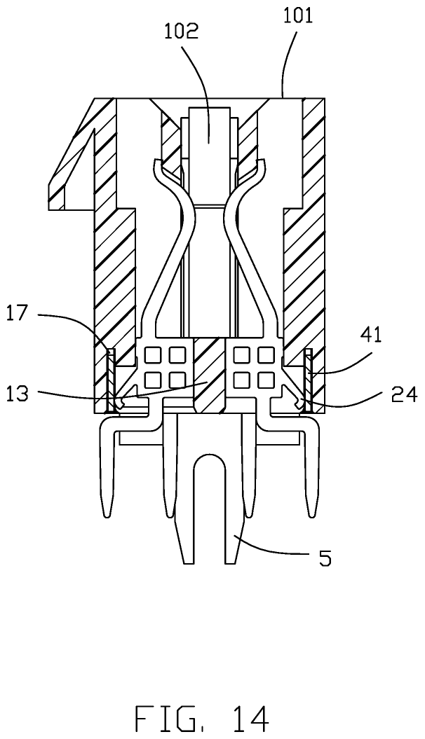

Referring to FIGS. 8-14 illustrating a second embodiment of a card edge connector 100′ which is similar to the first embodiment of the connector 100 except the engagement of the ground contacts and the ground. Hereinafter same elements are labeled with same numbers and only featured structures and elements will be described hereinafter. Each contact further defines a spring finger 25 extend outward from the outer edge 221 towards the ground member 4. The long plates 41 are vertically retained in the bottom wall 13 and the retaining portions 410 are located at a high level. The spring fingers 25 of the ground contacts 2G slant downward and press against the long plate 41 of the ground member 4. The signal contacts 2S have spring fingers as well as the ground contacts, so the long plates 41 define incisions 410 so that the spring fingers of the signal contacts go across the incisions and press against the insulating housing. Consequently, downward extending ribs 411 are formed between every adjacent incisions 410. The slating spring fingers 25 contact the extending ribs 411 so as to increase elasticity. In alternative embodiment, the signal contacts are formed without any spring fingers 25. Two adjacent signal contacts are formed as a pair of differential sign contacts, each pair of differential signal contacts are surrounded with two ground contacts 2G at each side thereof.

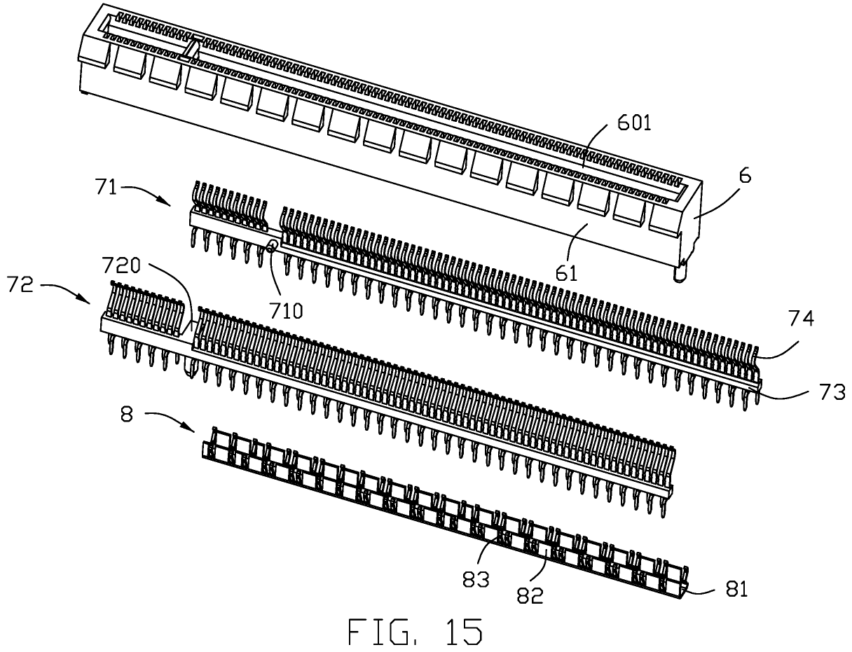

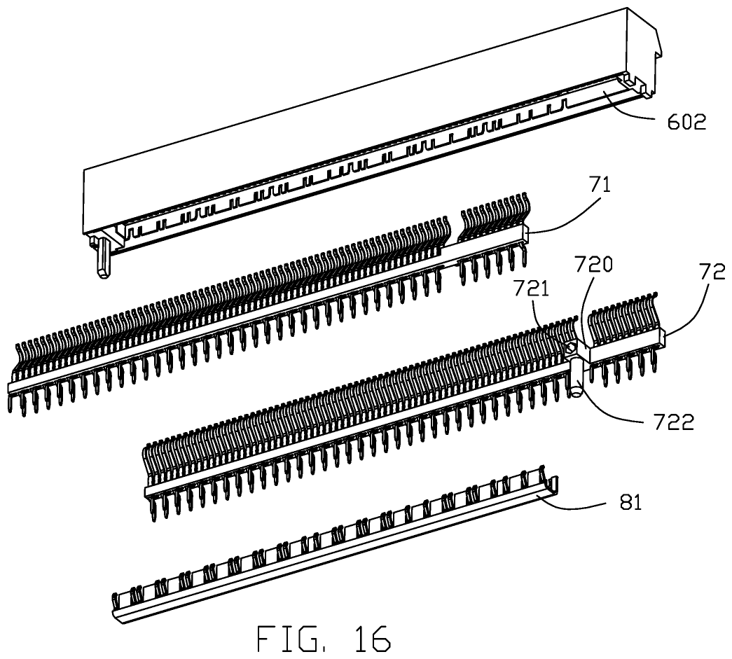

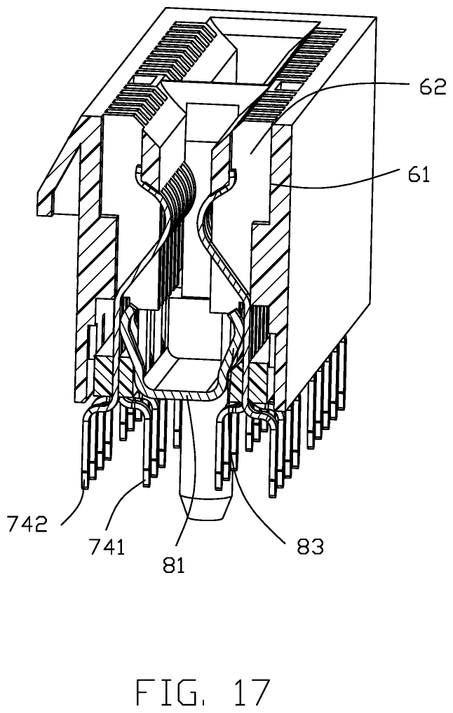

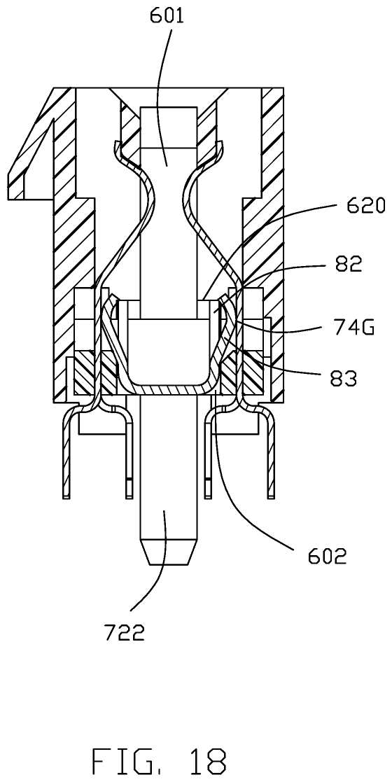

Referring to FIGS. 15-18 illustrating a third embodiment of this present invention, each contact module includes an insulator 73 and contacts 74 retained in the insulator 73, the contacts 74 include signal contacts 74S and ground contacts 74G, each row of contacts is a pattern of inner leg portion 741 and outer leg portion 742 as best shown in FIG. 17. The two contact modules 71, 72 are assembled into the mounting slot 602 from a bottom face. The mounting slot 602 upwardly communicates with the card slot 601. The second module 72 defines a retaining portion 720 projecting toward the first module 741 with a retaining hole 722 in a hexagon view or other shape in alternative embodiments. A positioning post 721 extend downward from the retaining portion. The first module 71 defines retaining post 710 projecting from the insulator toward the second module. The retaining post 710 is inserted and retained in the retaining hole 722 to assemble the two modules together.

Referring to FIGS. 15 and 17, the ground member 8 includes a main plate 81 and two vertical long plates 82 bending from opposite longitudinal edges of the main plate 81. Please notes, the inner leg portions 741 are located under the main plate 81. The ground member 8 includes spring finger 83 which connect with the ground contacts 70G. The spring fingers 83 are punched out from the vertical plate 82. The ground member 8 is sandwiched between the first and second module 71, 72 and the spring fingers press against the ground contacts 2G at the retaining portion to form a sub-assembly. Then the sub-assembly are inserted the mounting slot 602 from a bottom face. The vertical plates 82 are blocked beneath the bottom faces 620 of the partitioning ribs 62 for over up-movement of the ground member 8. The first and second modules 71, 72 are interfered with the inside of the long walls 62. The vertical plate 82 is interfered with the insulator 73.

While a preferred embodiment according to the present disclosure has been shown and described, equivalent modifications and changes known to persons skilled in the art according to the spirit of the present disclosure are considered within the scope of the present disclosure as described in the appended claims.

What is claimed is:

1. A card edge connector comprising:
a longitudinal insulating housing comprising two long walls and a bottom wall connecting with the long wall and defining a card slot in a longitudinal direction among the long walls and the bottom wall;
two rows of contact arranged in the long walls respectively, each contact comprising a retaining portion, a spring portion extending from the retaining portion and leg portion extending from the retaining portion and out of the insulating housing, the spring portions defining contacting portions projecting into the card slot;
wherein each contact is formed by directly punching out from a metal plate, the retaining portion defines an outer edge and inner edge interfered with the insulating housing and two opposite plane faces connecting with the outer and inner edge and disposed perpendicular to the longitudinal direction.

2. The card edge connector as claimed in claim 1, wherein each of the retaining portions defines at least one hole through the opposite plane faces.

3. The card edge connector as claimed in claim 1, wherein each of the retaining portions defines at least two holes through the opposite plane faces.

4. The card edge connector as claimed in claim 1, wherein the outer edge of each retaining portion is formed with bars and contacts the longer wall and the inner edges is located more near to the card slot than inner face of the longer wall.

5. The card edge connector as claimed in claim 1, wherein the retaining portion is in a square shape and defines four openings distinct from each other and arranged in two rows in a vertical direction.

6. The card edge connector as claimed in claim 1, wherein the card edge connector comprising a ground member retained in the longer wall, each row of contacts comprises signal contacts and ground contacts, the ground member defines spring fingers elastically contact the ground contacts.

7. The card edge connector as claimed in claim 6, wherein the ground member comprises two longer plates separate from the signal contacts, the spring fingers bend from a bottom edge of each longer wall and slant upward toward the longer plate

8. The card edge connector as claimed in claim 1, wherein the card edge connector comprises a ground member retained in the longer wall, each row of contacts comprises signal contacts and ground contacts; each of the ground contacts defines a spring finger, the spring fingers elastically contacts the ground member.

9. The card edge connector as claimed in claim 8, wherein a plurality of retaining ribs extent upward from an upper edge of longer plate and interfered with the long wall.

10. The card edge connector as claimed in claim 1, wherein the leg portions of each row of contacts are divided into two rows.

11. A card edge connector comprising:
a longitudinal insulating housing comprising two long walls and a bottom wall connecting with the long wall and defining a card slot in a longitudinal direction among the long walls and the bottom wall;
a row of contact arranged in the long wall, each contact comprising a retaining portion, a spring portion extending upward from the retaining portion with contacting portions projecting into the card slot, and leg portion extending downward from the retaining portion, the spring portions;
wherein each of the retaining portions define an outer edge and inner edge both interfered with the insulating housing and two opposite plane faces connecting with the outer and inner edge and disposed perpendicular to the longitudinal direction, the inner edges of retaining portions are aligned with the contacting portions from a top view.

12. The card edge connector as claimed in claim 11, wherein each of the retaining portions defines at least one hole through the opposite plane faces.

13. The card edge connector as claimed in claim 11, further comprising a ground member retained in the longer wall, wherein each row of contacts comprises signal contacts and ground contacts, one of the ground member and the ground contacts comprises spring fingers elastically contact another of the ground member and the ground contacts.

14. The card edge connector as claimed in claim 13, wherein the spring fingers extend from the inner edges of the retaining portions of the ground contacts and contact the ground member

15. The card edge connector as claimed in claim 14, wherein the signal contacts define spring fingers extend from the inner edges of the retaining portions thereof and do not contact the ground member.

16. A card edge connector comprising:
an insulative housing defining an upper card slot and a lower mounting slot both extending in a longitudinal direction and communicating with each other in a vertical direction perpendicular to the longitudinal direction;
two rows of passageways located by two sides of the card slot;
a pair of contact modules assembled to each other in a transverse direction perpendicular to both the longitudinal direction and the vertical direction, each of said contact modules including a plurality of contacts commonly integrally formed within an insulator and respectively received within the corresponding passageways and into the card slot, said contacts including a plurality of differential pair signals and grounding contacts alternately arranged with each other along the longitudinal direction;
a metallic grounding member held between the pair of contact module and commonly inserted into the housing along with the pair of contact modules; wherein
the grounding member includes a horizontal main plate with a pair of vertical plates on two sides, and a plurality of spring fingers are punched out from the vertical plates to mechanically and electrically connect to corresponding grounding contacts, respectively.

17. The card edge connector as claimed in claim 16, wherein the spring fingers downwardly press the corresponding insulator for restricting downward movement of the grounding member relative to the contact module.

18. The card edge connector as claimed in claim 16, wherein an upper end of each of the vertical plates upwardly abuts against the housing for restricting upward movement of the grounding member relative to the contact module.

19. The card edge connector as claimed in claim 16, wherein each grounding contact has a contacting section extending into the card slot, is locate above the corresponding spring finger in the vertical direction, and a soldering tail extending below the mounting slot and below the corresponding spring finger in the vertical direction.
